(19) United States
(12) Patent Application Publication
(10) Pub. No.: US 2006/0090910 A1
(43) Pub. Date: May 4, 2006

(54) Implement convertible between use configuration and transport configuration

(76) Inventor: Shane Houck, Pennville, IN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/185,441

(22) Filed: Jul. 20, 2005

Related U.S. Application Data
(60) Provisional application No. 60/589,992, filed on Jul. 20, 2004.

(51) Int. Cl. A01B 51/00

(52) U.S. Cl. 172/272

(57) ABSTRACT

The present forwardly-folding implement includes a telescoping tongue assembly, a main frame, a folding frame assembly, a rear frame assembly, left and right wing frame assemblies, and a readily replaceable toolbar assembly. The folding frame assembly is pivotally attached to the tongue assembly and to the left and right wing frame assemblies. The wing frame assemblies pivot vertically and horizontally from the rear frame assembly and optionally include powered wheel mechanisms or assist assemblies, which hydraulically pivot components of the instant implement between transport and operational configurations. When the present implement is being configured for transport, the tongue assembly is extended as the folding frame assembly and left and right wing frame assemblies are folded generally transversely to the rear frame assembly. Then, the wheel mechanisms are pivoted upwardly so that outboard portions of the wing frame assemblies are totally supported by the folding frame assembly.

### CROSS-REFERENCES TO RELATED APPLICATION

This application claims priority under 35 U.S.C. §119(e) to, and hereby incorporates by reference, U.S. Provisional Application No. 60/589,992, filed Jul. 20, 2004.

### FIELD OF THE INVENTION

This invention relates to agricultural implements and, in particular, this invention relates to foldable agricultural implements having wing frames

### BACKGROUND OF THE INVENTION

Forwardly foldable agricultural implements offer the advantage of maximizing the amount of soil area that can be covered by the implement, yet providing a minimum width when being stored or transported. Another advantage of these implements is that the folding structure present often serves to stabilize and maintain the wing structures in an orientation substantially perpendicular to the direction of travel while following ground contours during use. When in the use position, the wings on these implements are generally perpendicular to the direction of travel and have wheel assemblies that support a portion of or all of the weight of the respective wing. When in the transport position, being transported, the wings are generally oriented approximately to the direction of travel or may be upright. Conventionally, the necessary operational mechanisms and structural support framework has been quite complicated and bulky and heavy and to provide the folding operation to provide the robustness and strength needed in the agricultural environment. Typically an entire main frame portion above the wheels with pivot wings attached thereto is lifted by power to facilitate the folding of the wings to many known configurations. The entire weight of the wings are required to be lifted during the folding operation. In particular, the mechanism for conversion from the use position to the transport position need substantial move, lifting power and sizeable structural members to support, and lift the wing member and moreover, it is often necessary to transport the implement with the wing wheel mechanisms in contact with the road. The wing wheel mechanisms must then be adapted for use both in the use position and the transport position and are thus subjected to usage and wear during transport.

There is then a need for a foldable implement with mechanisms to support and fold and unfold the wings and to assist in configuring the implement for travel. There is a need for an implement addressing the above concerns, that is designed for minimal weight and is robust for extended use in agricultural environments and that has maximum capacity for mounting tanks and hoppers.

### SUMMARY OF THE INVENTION

This invention substantially meets the aforementioned needs of the industry by providing a foldable implement for being towed by a prime mover, in either which wheel mechanisms or hydraulic cylinders, in which extending or retracting a telescoping tongue assembly, converts the implement between a folded transport configuration and an extended use or operational configuration and in which the wheel mechanisms secure the wings, such that outboard portions of the wings are supported during transport at the wheel mechanisms.

In one aspect, the telescoping tongue is extended and retracted exclusively by a prime mover, an actuator, by a combination of hydraulic cylinders attached to wing links, by powered wing wheel mechanisms, or any combination thereof. Embodiments of the instant telescoping tongue will exclude hydraulic cylinders or equivalent structures directly attached to the telescoping tongue and which directly extend or retract the telescoping tongue.

In another aspect, the present invention provides a telescoping tongue, a main frame supported by wheels or tracks, a folding frame, a rear frame assembly, left and right wing frame assemblies, a lifting mechanism, and a toolbar assembly. The telescoping tongue is attachable to a prime mover, such as a tractor. The main frame may be attached to the tongue. The wheels or tracks are part of a transport assembly that is preferably attached to the bottom of the main frame and is removable. The transport assembly may include the plurality of tracked mechanisms or wheels or combinations and can be used on other implements. The folding frame may include left and right folding frame members pivotally attached to the tongue. The folding frame members function as connecting wing links or as diagonal wing links or braces, wherein the wing frame assemblies are supported during transport and are maintained in the unfolded configuration during use. The left and right wings comprising wing frame assemblies may be pivotal with respect to the main frame and to the folding frame. Each of the wing frame assemblies may include a wing frame, and either a powered wheel mechanism or a plurality of hydraulic cylinders or other powered means such as linear actuates. The powered wheel mechanism may include a hydraulic motor and may be retractable. The plurality of hydraulic cylinders are positioned to assist with and pivot the left and right wing frame assemblies and folding frame between the operational and transport configurations. The lifting mechanism may be positioned proximate the tongue for elevating and lowering the folding frame. The toolbar assemblies may be easily detachable from the rear frame assembly and the wing frame assemblies.

In another aspect, the present invention provides a method of configuring an implement from an extended-use or operational configuration to a folded transport configuration and vice versa. The implement may include a telescoping tongue assembly, extending from a main frame, a folding frame pivotally coupled to the tongue assembly, a rear frame assembly pivotally coupled to the main frame, and left and right wing frame assemblies pivotally coupled to the rear frame assembly and folding frame. Each of the left and right wing frame assemblies may include a powered wheel mechanism. The method may include: 1) actuating each wheel mechanism and extending the telescoping tongue assembly, thereby pivoting each of the left and right wing frame assemblies inwardly until each of the wheel mechanisms contact the folding frame; and 2) pivoting the wheel mechanisms until the left and right wing frame assemblies repose on the folding frame.

In yet another aspect, the present invention provides a method of manufacturing an implement. The method may include: 1) attaching a telescoping tongue assembly to a main frame; 2) pivotally coupling a rear frame assembly to the main frame; 3) pivotally coupling left and right wing frame assemblies to the rear frame; and 4) pivotally coupling a folding frame assembly to the tongue assembly and to each of the left and right wing frame assemblies.

There is provided an implement configurable between a folded transport position and an extended use position and having a telescoping tongue, a yoke, a main frame, a rear frame, generally opposed wing frames and wing links. The tongue extends from the main frame and supports the yoke, which pivots between a raised position and a lowered position. The rear frame is hingeably attached to each of the wing frames and, with the wing frames, is pivotally raised and lowered with respect to the main frame. Front ends of the wing links are pivotably attached to the yoke. The wing links are also pivotably attached to corresponding wing frames at locations proximate the ends of the wing links. In the folded position, in one embodiment of this invention, the wing frames are supported by the wing links, the wing links, in turn, supported by the telescoping tongue.

There is also provided an implement with wing tool bars pivotably attached to corresponding wing frames. In one embodiment, these wing tool bars are raised or lowered by rotating the tool bar with respect to, or about, the corresponding wing frame, e.g., with an axis of rotation about the center (longitudinal axis) of the wing frame.

There is further provided an implement configurable between a folded transport position and an extended use position and having a telescoping tongue, a yoke, a main frame, a rear frame, generally opposed wing frames and wing links. The tongue extends from the main frame and supports the yoke, which pivots between a raised position and a lowered position. The rear frame is hingeably attached to an inboard end of each of the wing frames and, with the wing frames, is pivotally raised and lowered with respect to the main frame via at least one four-bar link mechanism, which, in turn, is raised and lowered by at least one main frame hydraulic cylinder. Outboard portions of the wing frames are supported by wheel mechanisms, which may include hydraulic cylinders. The wheel mechanisms cooperate with the main frame hydraulic to raise and lower the wing frames by extending or retracting the wheel mechanism hydraulic cylinders. Front ends of the wing links are pivotably attached to the yoke. The wing links are also pivotably attached to corresponding wing frames at locations proximate the ends of the wing links. In the folded position, in one embodiment of this invention, the wing frames are supported by the wing links, the wing links, in turn, supported by the telescoping tongue. When being supported by the wing links, the wing frames may optionally be secured to the wing links by retracting the wheel mechanism hydraulic cylinders until the wheels contact lower surfaces of the wing links.

There is yet further provided an implement with a foldable frame assembly and a telescoping tongue assembly extending from a main frame, which is at least partially extended and retracted with respect to the main frame by movement of a prime mover.

It is one feature of particular embodiments of the present implement that the main frame thereof may be supported by tracks, which may be made from a rubberized synthetic resin. It is an advantage of the foregoing feature that the main frame can support substantially heavier loads and operate with more efficiency and less energy when being towed over unpacked soils.

It is another feature of particular embodiments of the present implement that the main frame remains at a constant height, only the rear frame assembly and left and right wing frame assemblies being raised and lowered during use. It is an advantage of the foregoing feature that the main frame better accommodates the substantially larger loads capable of being sustained thereby.

It is yet another feature of particular embodiments of the present implement that the wing frame assemblies are rotated approximately 90 degrees forwardly from the use configuration to the transport configuration. It is an advantage of the foregoing feature that the implement is configured with a minimum width when configured for transport. It is another advantage of the foregoing feature that the implement has a maximum width during use and, therefore, a capacity to plant or till a maximum area of soil.

It is yet another feature of some embodiments of the implement of this invention that the main frame thereof provides ample space and support to accommodate additional implements. It is one advantage of the foregoing feature that the main frame supports large tanks or other devices thereon so that additional operations (e.g., applying fertilizer, pesticides) can be performed in a single pass.

It is yet another feature of particular embodiments of the instant implement that the main frame cannot be raised or lowered. It is an advantage of the foregoing feature that the implement can be configured for use or transport with considerably less hydraulic lifting capacity that if the main frame were raised or lowered when the implement was being configured for use or transport.

It is yet another feature of some embodiments of the implement of this invention that a telescoping tongue is present. It is a feature of the foregoing advantage that the implement is more compact for field operation and use.

It is still yet another feature of particular embodiments of this invention that a track suspension is used to support and provide means for transporting the implement during use and transport. It is an advantage of the foregoing feature that the tracks provide “flotation” over frequently soft soils to accommodate larger seed and fertilizer containers. It is yet another advantage of the foregoing feature that the tracks can be removed and utilized in other implements, e.g., grain carts, in some embodiments.

It is still another feature of particular embodiments of the implement of the present invention that the wing braces support the wing frames and wing toolbars during transport. It is an advantage of the foregoing feature that the wing frames and wing tool bars are more widely spaced during transport, thereby providing more space to mount larger tanks and hoppers atop the main frame.

It is yet another feature of particular embodiments of the present implement that component toolbars can be interchanged quickly and easily. It is an advantage of the foregoing feature that the implement can be quickly and easily adapted for a maximum number of operations, e.g., planting, applying fertilizer or pesticides, and tillage.

It is yet another feature of particular embodiments of the present implement that the outboard wing support wheels are powered. It is an advantage of the foregoing feature that the powered wing support wheels provide at least some of the power necessary to pivot the wing frame assemblies between the use configuration and the transport configuration.

It is yet another feature of particular embodiments of the instant implement that a plurality of hydraulic cylinders are present to pivot the implement between the transport configuration and the operational configuration. It is an advantage of the foregoing feature that the hydraulic cylinders are often capable pivoting the instant implement without the prime mover providing assistance in the form of backing or moving forward when the instant implement is being configured as described.

It is yet another feature of particular embodiments of the present implement that the tongue assembly includes telescopic inner and outer members. It is an advantage of the foregoing feature that the tongue assembly can be extended and retracted when the present implement is being pivoted between a transport configuration and a use configuration, thereby providing at least some of the power therefore.

It is yet another feature of particular embodiments of the present implement that the outboard wing support wheels can be retracted. It is an advantage of the foregoing feature that the outboard portions of the wing frame assemblies can be supported by the folding frame assembly when the present implement is in the transport configuration.

It is yet another feature of particular embodiments of the present implement that the outboard wing support wheels, specifically the pneumatic tires, are utilized to support or engage the wing assemblies with respect to the main frame when the wing frame assemblies are in the transport position. This provides shock absorption relative to the main frame-wing frame engagement minimizing stress on the other frame components. This allows manufacture with smaller and lighter weight structural components, facilitating easier and less expensive manufacture.

It is another feature and advantage of particular embodiments of the present invention that the pivoting connection of the front folding frames to the main frame is by way of a ball joint or other joint assembly pivotal about more that one axis. This provides shock absorption relative to the main frame-folding frame engagement minimizing stress on the other frame components. This allows manufacture with smaller and lighter weight structural components, facilitating easier and less expensive manufacture. The support of the wing members substantially between the ball joint near the rear of the implement and the tires near the front of the implement

It is yet another feature of particular embodiments of the present implement that the telescoping tongue includes a pivotable yoke. It is an advantage of the foregoing feature that the yolk may be pivoted upwardly to raise the folding frame assembly, thereby enabling outboard portions of the wing frame assemblies to be supported by the folding frame assembly.

Another feature of certain embodiments of the instant implement is that wings are offset by a hinged pivot mechanism. One advantage of the foregoing feature is that the outboard wing lift wheels (mechanisms) are positioned for proper alignment when the implement is turned in fields during use. Another advantage of the foregoing feature is that the offsets provide for a more narrow implement width with the implement is configured in the transport position, thereby providing for an implement that can be more safely and easily transported.

Yet another feature of particular embodiments of the implement of this invention is that the wing tool bars are rotated about 90 degrees when being configured between the use position and transport position. One advantage of the foregoing feature is that the raised tool bars provide more space objects such as tanks or hoppers when the implement is configured in the transport position.

Still another feature of some embodiments of the instant implement is that the tool bars are quickly and easily installed and removed therefrom. One advantage of the foregoing feature is that these interchangeable tool bars can enable the frame to be more economically utilized for several operations (e.g., seeding, fertilizer and pesticide application, tillage) during the year, thereby eliminating the need to purchase and maintain separate implements for each of these operations.

These and other objects, features, and advantages of this invention will become apparent from the description which follows, when considered in view of the accompanying drawings.

### BRIEF DESCRIPTION OF THE DRAWINGS

FIG. 1 is a plan view of one embodiment of the instant implement in an operational configuration;

FIG. 2 is a plan view of the implement of FIG. 1 configured between the operational position of FIG. 1 and a transport position;

FIG. 3 is a plan view of the implement of FIG. 1 in a transport configuration;

FIG. 4 is a plan view of one embodiment on the yoke of the implement of FIG. 1;

FIG. 5 is a side view of the yoke of FIG. 4 in a raised position;

FIG. 6 is a sided view of the yoke of FIG. 4 in a lowered position;

FIG. 7 is a perspective view of the implement of FIG. 1;

FIG. 8 is a perspective view of the lower, rear portion of the implement of FIG. 1;

FIG. 9 is a rear view of the implement of FIG. 1;

FIG. 10 is a side view of the implement of FIG. 1, a fertilizer tank depicted in phantom, the implement in a raised configuration;

FIG. 11 is a perspective view of a portion of a wing frame assembly of the implement of FIG. 1;

FIG. 12 is a perspective view of one embodiment of a wheel assembly of the implement of FIG. 1;

FIGS. 13 and 14 are perspective views of a second embodiment of the wheel assembly of the implement of FIG. 1;

FIGS. 15 and 16 are perspective views of another embodiment of the instant implement in an operational configuration and a transport configuration, respectively;

FIG. 17 is a side view of the instant implement configured in a transport configuration;

FIG. 18 is a side view of the instant implement, the tool bars attached thereto in a raised configuration;

FIG. 19 is a side view of the instant implement in an operational configuration;

FIG. 20 is another embodiment of a yoke assembly operably attached to the instant implement and in a lowered configuration;

FIG. 21 is a perspective view of the yoke assembly of FIG. 20 in a raised position;

FIGS. 22 and 23 are respective plan and perspective views of one embodiment of a tool bearing of this invention locked in a lowered position;

FIGS. 24 and 25 are respective plan and perspective views of the bearing of FIG. 22 in a lowered, unlocked position;

FIGS. 26 and 27 are respective plan and perspective views of the bearing of FIG. 22 in a raised position;

FIG. 28 is a plan view of another embodiment of the instant implement in an operational configuration;

FIG. 29 is a plan view of the implement of FIG. 28 intermediate between an operational configuration and a transport configuration.

FIG. 30 is a plan view of an assist assembly present in the implement of FIG. 28;

FIG. 31 is a perspective view of another assist assembly present in the implement of FIG. 28.

It is understood that the above-described figures are only illustrative of the present invention and are not contemplated to limit the scope thereof.

### DETAILED DESCRIPTION

Unless otherwise defined, all technical and scientific terms used herein have the same meaning as commonly understood by one of ordinary skill in the art to which this invention belongs. Although methods and materials similar or equivalent to those described herein can be used to practice the invention, suitable methods and materials are described below. Any references to such relative terms as forward and rearward, front and back, right and left, top and bottom, upper and lower, horizontal and vertical, or the like, are intended for convenience of description and are not intended to limit the present invention or its components to any one positional or spatial orientation.

Each of the additional features and methods disclosed herein may be utilized separately or in conjunction with other features and methods to provide improved connectors and methods for making the same. Indeed, a person of ordinary skill in the art will readily appreciate that individual components shown on various embodiments of the present invention are interchangeable to some extent and may be added or interchanged on other embodiments without departing from the spirit and scope of this invention. This description is merely intended to teach a person of skill in the art further details for practicing preferred aspects of the present teachings and is not intended to limit the scope of the invention. Therefore, combinations of features and methods disclosed in the following detailed description may not be necessary to practice the invention in the broadest sense, and are instead taught merely to particularly describe representative embodiments of the invention.

The terminology “connected to”, “attached to” and “extending from” do not require direct component-to-component contact but can have intermediate components.

By “principal direction of travel” is meant the direction indicated by the tongue of the instant implement.

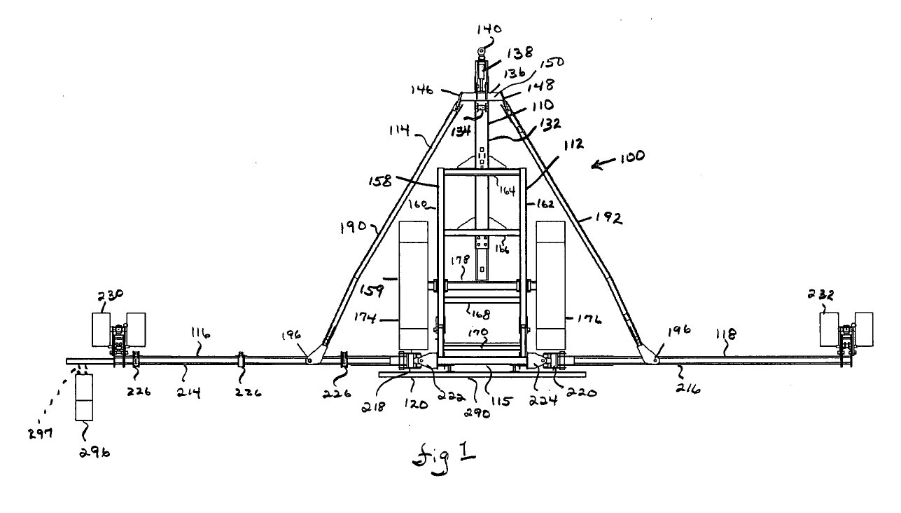

One embodiment of the implement of this invention is depicted in the figures generally at 100. The implement 100 is towed by a prime mover such as a tractor 102 (not shown) when being towed or used for activities such as planting and tillage. Referring to FIGS. 1-3, the implement 100 may be considered to include a telescoping tongue assembly 110, a main frame 112, a folding frame assembly 114, a wing support assembly, such as a rear frame assembly 115, respective left and right wing frame assemblies 116 and 118, and an interchangeable toolbar assembly 120.

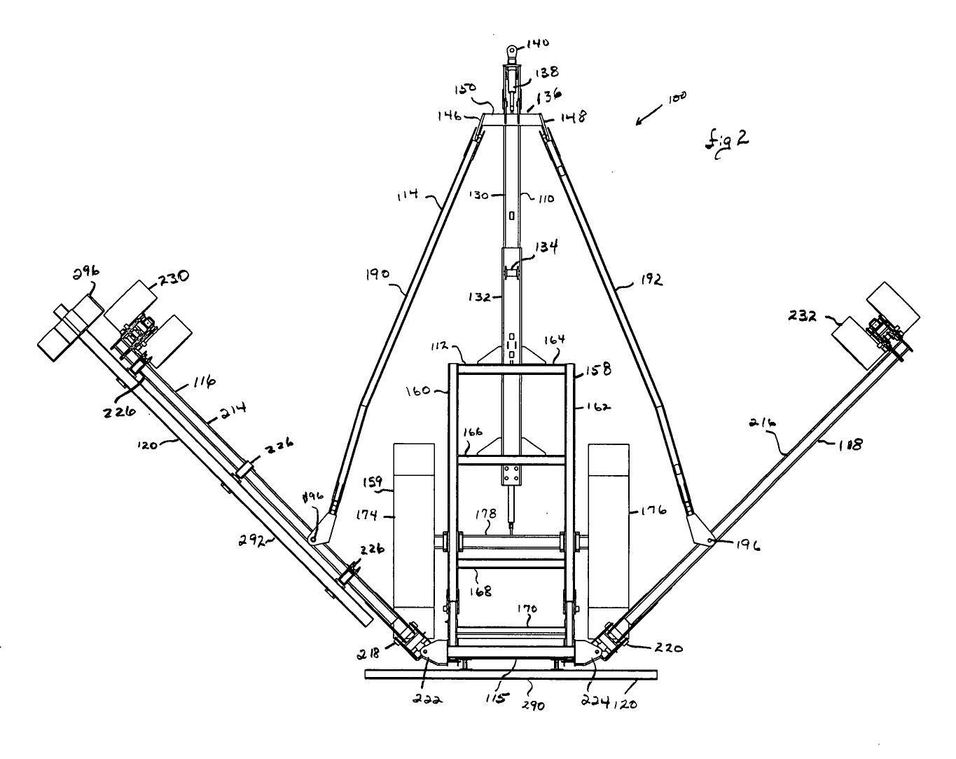

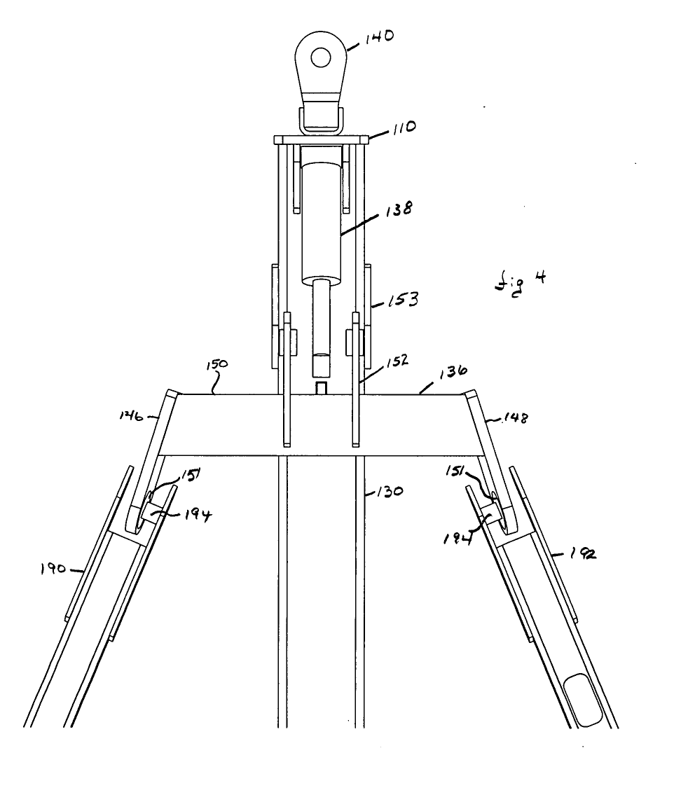

As best seen in FIGS. 2-6, the instant tongue assembly 110 includes respective and telescopic inner and outer members 130 and 132, a bracket 134, a moveable yoke 136, a hydraulic cylinder (ram) 138, and a hitch 140. In the embodiment shown, the tubular inner and outer telescopic members 130 and 132 are generally square in cross section and are dimensioned such that the inner member 130 is slidably accommodated in the outer member 132. The bracket 134 is affixed proximate a foreword end of the outer member 132. The yoke 136 is located at the forward ends of the instant folding frame members, which are more fully discussed below and has respective left and right arms 146 and 148. The left and right arms 146 and 148, in turn, the ball joint 151 connects the yoke arms 146 and 148 to the forward ends of the left and right folding frame members to allow both vertical and horizontal pivoting therebetween are affixed to a cross member 150. Each of the left and right arms 146 and 148 terminate in a pivot, such as a ball joint 151. The cross member 150, in turn, is attached to a first yoke bracket member 152. The first yoke bracket member 152 is pivotally attached to a second yoke bracket member 153 by means of a pin 154. The second yoke bracket member 153 is attached to the inner telescopic member 130. The bracket 134 is dimensioned and positioned such that the yoke cross member 150 can be lowered to abut a rearward surface of the bracket 134 and can be raised to clear the bracket 134. The hydraulic cylinder 138 is mounted to a connection such as a pin 156 on the first yoke bracket member 152 and to the inner member 130 proximate a foreword end thereof. When the yoke cross member 150 abuts the rearward surface of the bracket 134, the tongue inner member 130 cannot be displaced (extended) from within the tongue outer member 132 and thus locks the inner member 130 in place with respect to the outer member 132, e.g., when the instant implement is being used in the field. When the yoke cross member 150 is pivoted to clear the bracket 134, the tongue inner member 130 can be telescopically extended by moving the tractor forward and telescopically retracted by moving the tractor rearwardly. As discussed below, wheel assemblies and pivot assist assemblies of some embodiments of this invention and pivot assist assemblies of yet other of the instant embodiments also cooperate to extend and retract the telescoping tongue assembly of this invention. The inner member 130 is telescopically extended and retracted when the present implement is being configured for transportation or use, respectively. Optionally, a hydraulic cylinder (not shown) may be present to extend and retract the instant telescoping tongue.

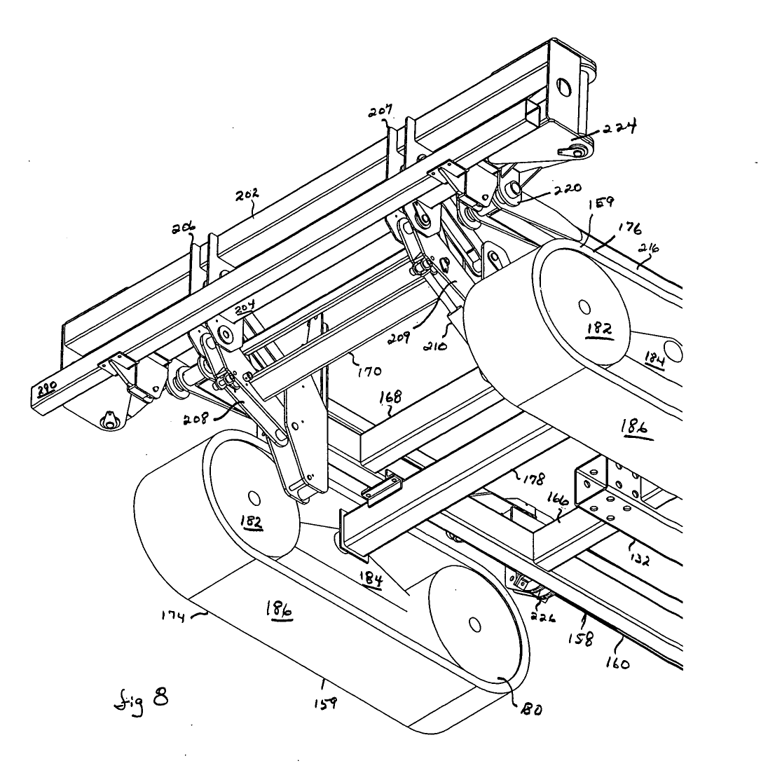

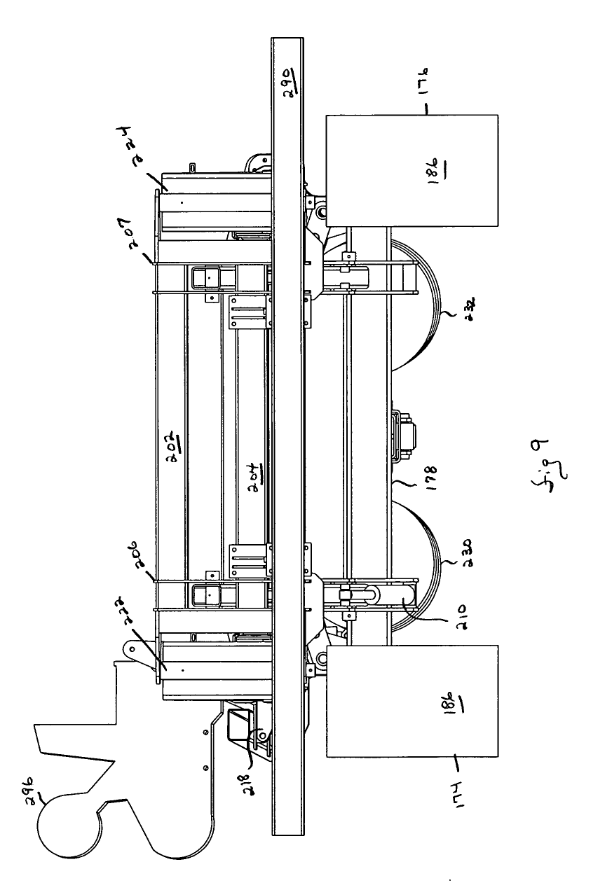

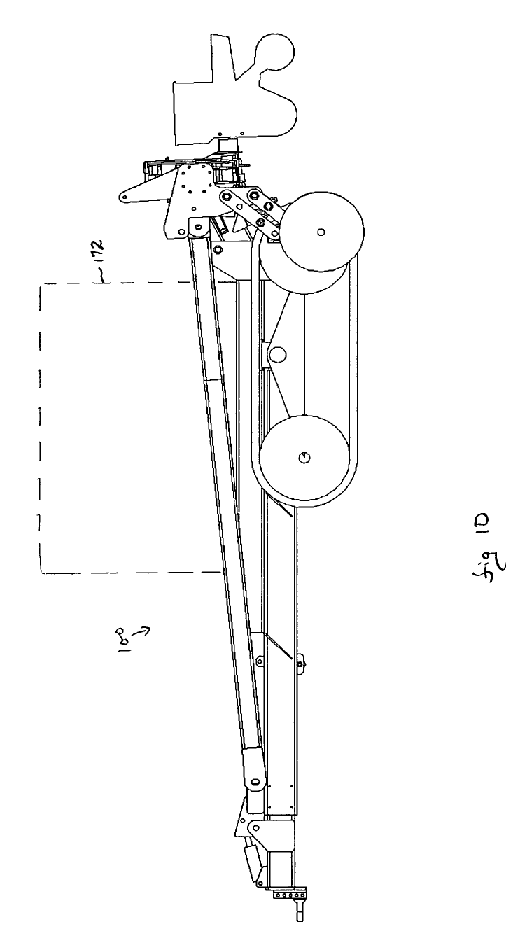

Referring to FIGS. 1-3 and 7-10, the main frame 112 includes a frame assembly 158 and is supported by a transport assembly 159. In the embodiment depicted, the frame assembly 158 includes respective left and right longitudinal frame members 160 and 162 and a plurality of cross members such as respective first, second, third, and fourth cross members 164, 166, 168, and 170 extending between the left and right longitudinal frame members 160 and 162. However, the exact composition and disposition of the frame members may vary considerably, depending upon such factors as the size of the instant implement, and the magnitude and nature of loads to be supported thereon, such as a fertilizer tank shown in phantom at 172 in FIG. 10. The instant telescoping tongue assembly 110 extends from a front of the main frame 112.

In the embodiment depicted, the instant transport assembly 159 includes respective left and right track assemblies 174 and 176 and a cross member 178 extending between the instant left and right track assemblies. Each of the present left and right track assemblies has respective front and rear wheels 180 and 182 connected in tandem by an axle frame 184. The instant front and rear wheels are rotatably disposed within a track 186, which may be made from a rubber-resembling synthetic resin or a suitable metallic material. Other wheels may be present in other embodiments of the instant track assembly. Moreover, other transport assemblies may include pluralities of wheeled embodiments used without tracks as well. By using track assemblies, greater weights can be supported on the soft soils often present in the fields during planting and tillage and better traction is provided facilitating the extension and retraction of the wing members by the rearward and forward motion of the prime mover.

Referring to FIGS. 1-3 and 7-9, the folding frame assembly 114 has connecting wing links or diagonal wing links or braces, such as respective left and right folding frame members 190 and 192. The left and right folding frame members 190 and 192 are generally tubular and accommodate pins 194 and 196. The pins 194 attach each of the left and right folding frame members 190 and 192 to the ball joints 151 of the yoke left and right arms 146 and 148 to allow the frame members 190 and 192 to pivot vertically and horizontally. The pins 196 pivotally attach the left and right frame members 190 and 192 to the wing frame members (discussed below).

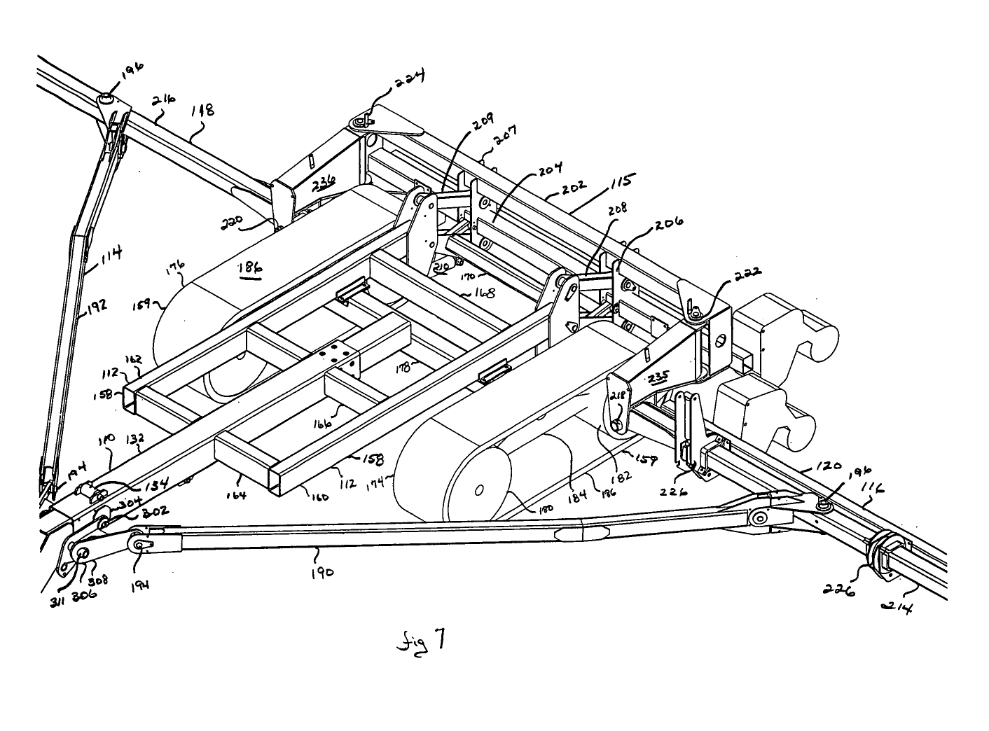

Referring mainly to FIGS. 7-9, the rear frame assembly 115 may include upper and lower members 202 and 204, brackets 206 and 207, four-bar linkages 208 and 209, and at least one, e.g., two hydraulic rams 210. A plurality of generally vertical cross members (not shown) and the bracket 206 may fix the upper and lower members 202 and 204 in rigid juxtaposition. The four-bar linkage 208 pivotally connects the upper and lower members 202 and 204 via the bracket 206 to a back of the main frame 112. The hydraulic rams 210 are connected to a lower member of the four-bar linkage and to the main frame 112, thereby raising and lowering the rear frame assembly 115 and wing frame assemblies as desired. However, a person of ordinary skill in the art will readily recognize that tool bars can be attached directly to the main frame, e.g., with the four-bar linkage. Hence the rear frame may not be present in some embodiments of this invention.

As seen in FIGS. 1-3, 7, and 11, the instant left and right wing frame assemblies 116 and 118 are operably positioned at the left and right of the mainframe 112 and respectively include left and right wing frame members 214 and 216, left and right vertical hinges 218 and 220, left and right horizontal hinges 222 and 224, left and right bell cranks 226 and 228, and left and right wheel mechanisms 230 and 232. The inboard ends or portions of the wing frame members 214 and 216 pivot generally vertically on the pivots or horizontal hinges 218 and 220 but may not be non-rotational about their elongate axis in this particular embodiment. The horizontal hinges 218 and 220, a turn, pivot generally horizontally from the rear frame assembly 115 by means of the pivots with vertical axis or generally vertical hinges 222 and 224. The left and right wing frame members 214 and 216 are connected to the folding frame members 190 and 192 and may vertically and horizontally pivot with respect to the instant folding frame members 190 and 192. In the embodiment depicted in FIG. 7, respective dog leg members or offsets 235 and 236 distance the vertical hinges 222 and 224 from vertical hinges 218 and 220. The offsets 235 and 236, if present, displace the wing frame members forwardly from the rear frame. The wing tool bars (discussed below) are connected to the instant wing frame assemblies via the bell cranks. Each of the bell cranks 226 and 228 may utilize at least one hydraulic cylinder (ram) 234 (not shown) to vertically pivot the wing toolbars.

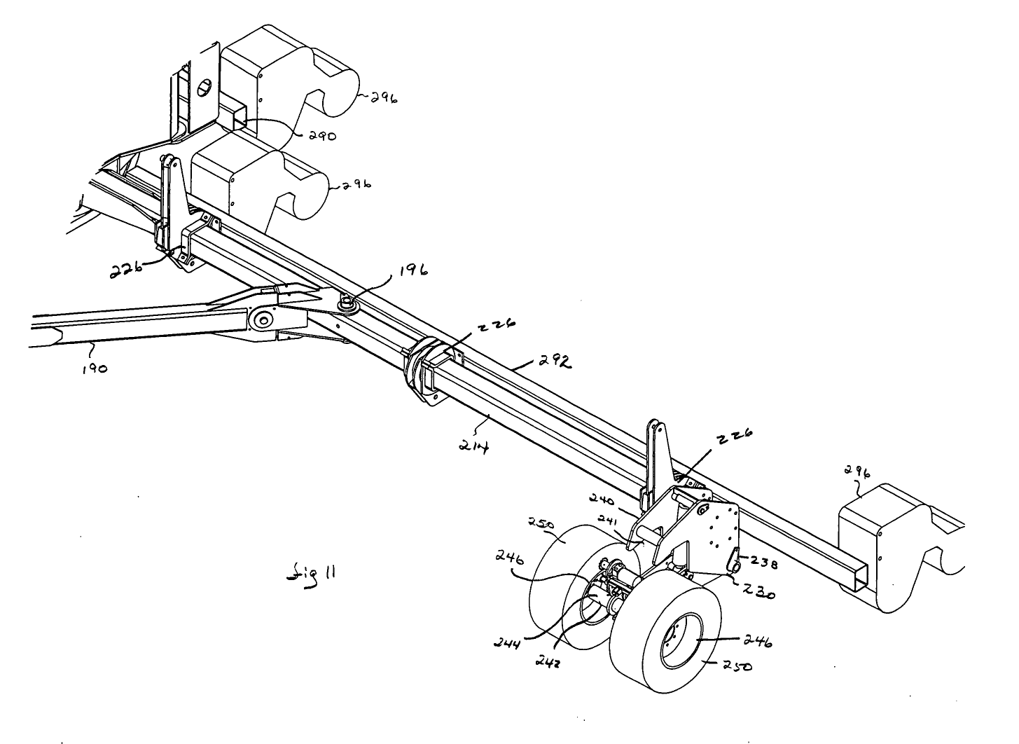

As seen in FIGS. 11-12, each of the left and right wheel mechanisms 230 and 232 is attached to an outboard portion one of the wing frame members 214 and 216 by means of wheel support, such as a bracket 238. The bracket 238 has a horizontal element 240 such as a link engagement piece configured as a hook forwardly extending from an upper portion thereof. A lower edge of the forward element defines a notch 241 dimensioned to accommodate a cross sectional dimension of the folding frame members 190 and 192. A wheel mechanism element 242 pivotally depends from the bracket 238 and is attached to an axle housing 244. A plurality of rims 246 are attached to the axle disposed in the axle housing 244. A generally circular series of gear teeth 248 (not shown) is present on an inner periphery of each of the rims 246 and a tire (e.g., pneumatic) 250 is disposed about each of the rims 246 as well. A hydraulic motor 252 is a secured to a bracket 253. The bracket 253, in turn, is pivotally attached to a lower portion of the wheel mechanism element 242 operably proximate the axle housing 244. A hydraulic cylinder (ram) 254 is pivotally attached to an upper portion of the bracket 240 and to the wheel mechanism element 242 to thereby raise and lower the wheel mechanism element 242 as desired. The hydraulic motor 252 rotates a motor shaft 258, thereby also rotating a sprocket 260 attached to the motor shaft 258. The sprocket 260 drives a chain 262 (not shown). The chain 262, in turn, is meshed with a sprocket 264 (not shown) so as to rotate a jack shaft 266. The sprockets 268 are attached to each end of the jack shaft 266 so as to mesh with the gear teeth 248 on each of the rims 246 when pivoted into position. The sprockets 268 are pivoted to engage and disengage when the bracket 253 is pivoted by a cam 270. The cam 270 is in mechanical communication with the jack shaft 266, e.g., by means of a slip clutch 272. Thus, when the jack shaft 266 is rotated, the cam 270 pivots, thereby contacting the axle housing 244 and pivoting the bracket 253. When the bracket 253 is pivoted, the sprockets 268 are, in turn, pivoted to engage or to disengage with the rim teeth 248. As the jack shaft 266 continues to rotate, the slip clutch 272 maintains the bracket 253 in position so that the sprockets 268 continue to mesh with the rim teeth 248. When the jack shaft ceases turning, the positive force maintaining the sprockets 268 in position to mesh with the rim teeth 248 ceases as well and the sprockets 268 then disengage. When the sprockets 268 are disengaged from the rim teeth 248, the wheels may turn freely, e.g., for field operations.

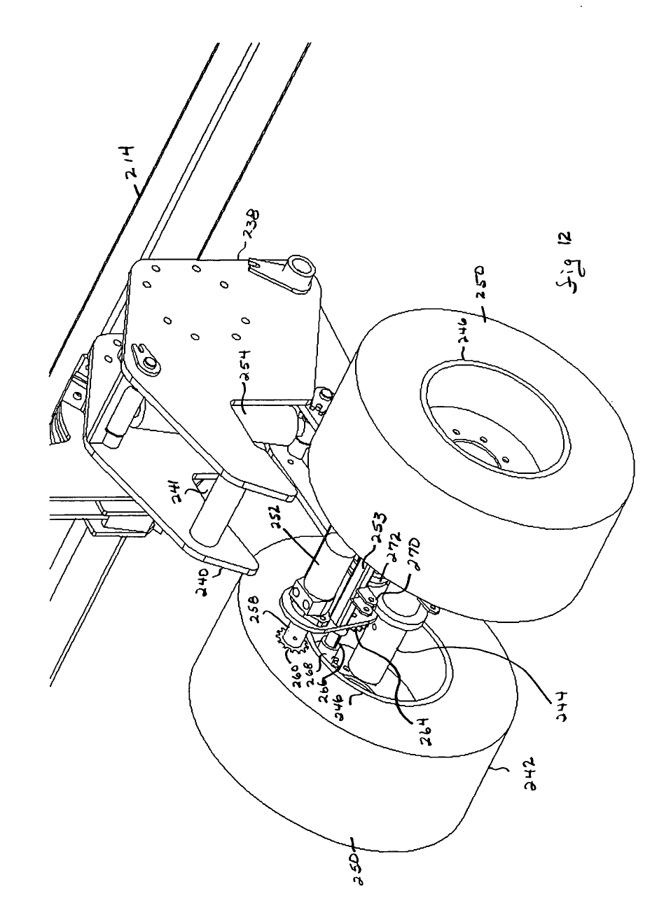

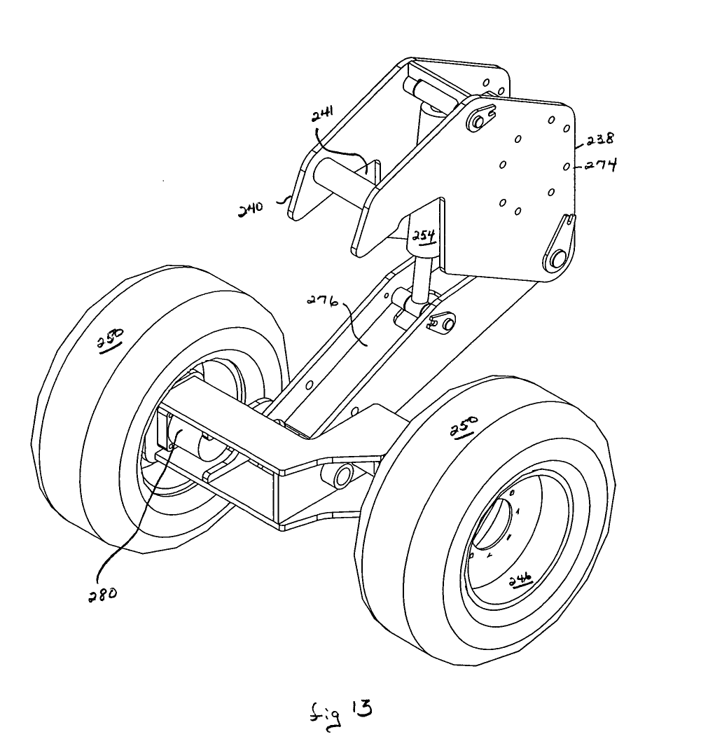

Another embodiment of the instant left and right wheel mechanism is depicted at 274 in FIGS. 13-14, in which components similar to the previous embodiment are indicated with identical numerals. The wheel mechanism 274 depicted differs from the previous embodiment in that a hydraulic motor 276 directly drives one or both offset axles 278 and 280. However one or both of the offset axles 278 and 280 can be driven by other means, such as the chain drive discussed above. Moreover, a separate hydraulic motor can directly or indirectly drive each of the offset axles 278 and 280 as well.

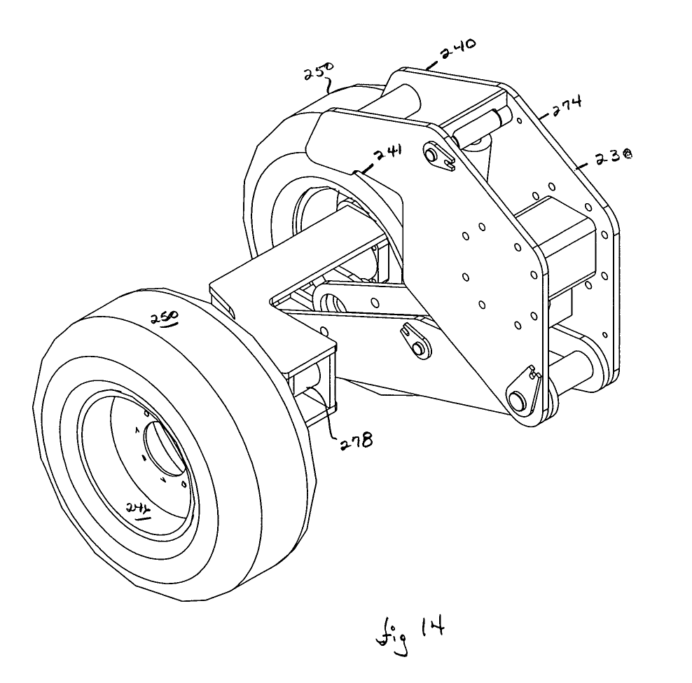

Referring again to FIGS. 1-3 and 15-16, the toolbar assembly 120 comprises a center toolbar 290 and respective left and right wing toolbars 292 and 294. The center toolbar 290 may be attached to one of the upper or lower rear frame members 202 and 204, e.g., by U-bolts, and is raised or lowered by the hydraulic rams 210 when the rear frame assembly is raised. The left and right wing toolbars 292 and 294 are attached to the left and right wing frame members 214 and 216 by means of the left and right bell cranks 226 and 228 and are raised and lowered as desired by operating the hydraulic rams 234. Because the tool bars are attached to frame members by U-bolts or bell cranks, the tool bars may be replaced easily and quickly for repair or to accommodate various implements for planting, tillage, and applying granular or liquid fertilizers or pesticides. Thus, a significant and advantageous feature of this invention is that the instant implement may interchangeably and efficiently accommodate several tool bars with differing application, e.g., planters, chisels, and the like. Because the wing frame assemblies 116 and 118 are pivotally connected to the rear frame assembly 115, the wing frame assemblies 116 and 118 are raised and lowered when the rear frame assembly 115 is raised or lowered as well. Planter units 296 may be attached to the instant center and wing toolbars conventional structure 297 readily comprehended by a person of ordinary skill in the art. However, a person of ordinary skill in the art will readily appreciate that other units, e.g., chisel members, sweeps, and/or disks for tillage, may be attached as well.

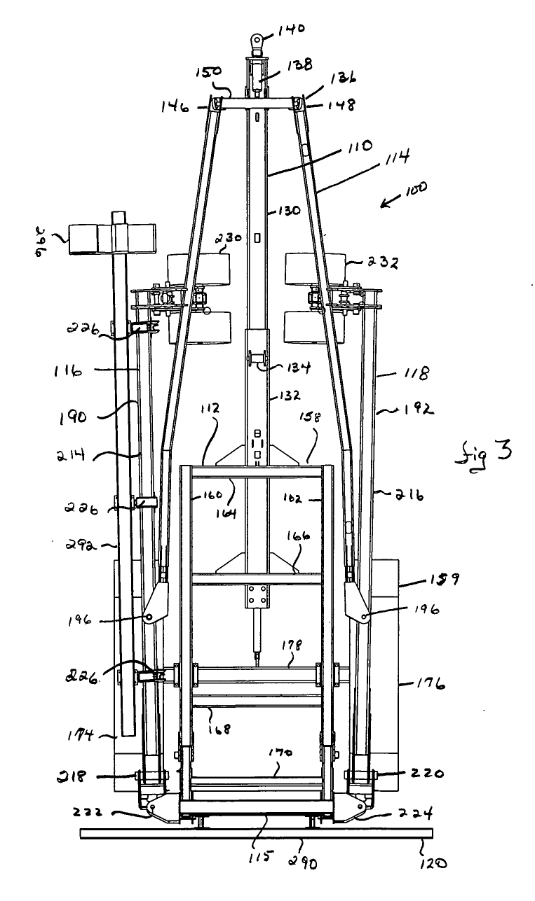

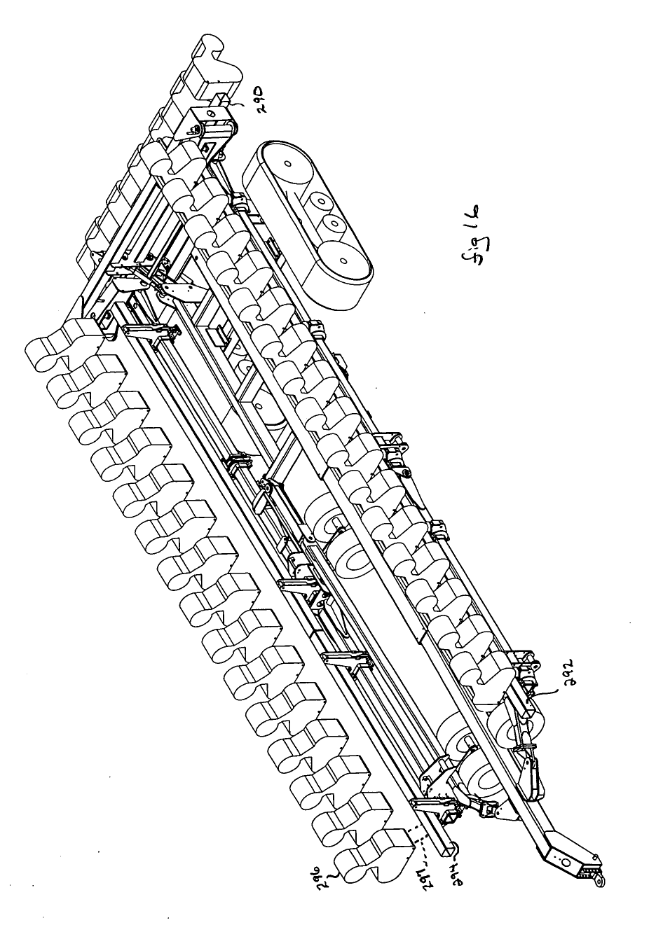

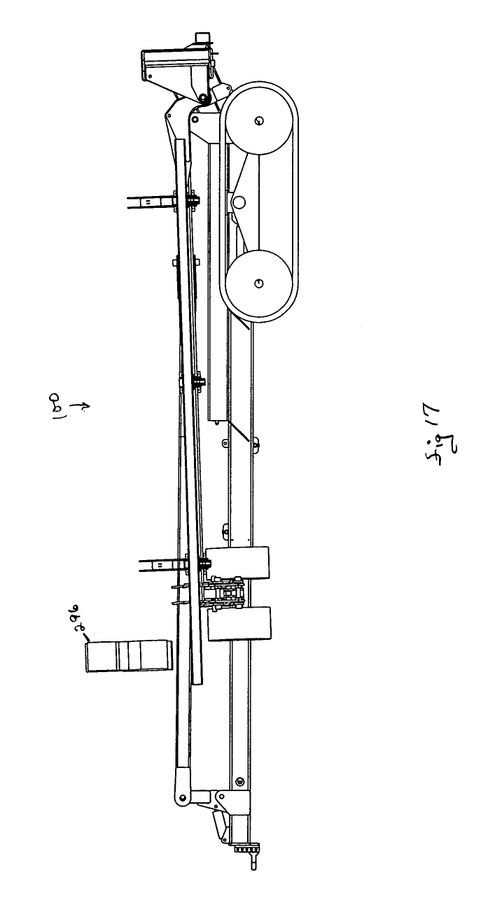

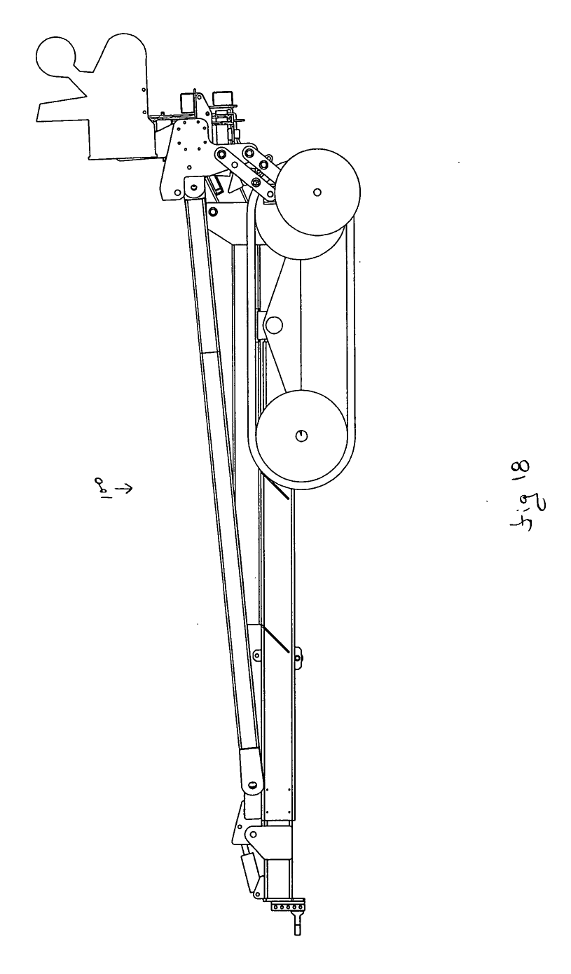

The present implement is depicted in a transport configuration in FIGS. 3 and 16-17. In the transport configuration, the folding frame assembly 114 and left and right wing frame assemblies 116 and 118 are raised and folded inwardly as shown and the tool bars are pivoted to a raised position. The instant implement is reconfigured to be used by unfolding the folding frame assembly 114 and left and right wing frame assemblies 116 and 118 to the configuration depicted in FIGS. 1 and 18. The toolbars may then be lowered to the position as depicted in FIG. 19 for use.

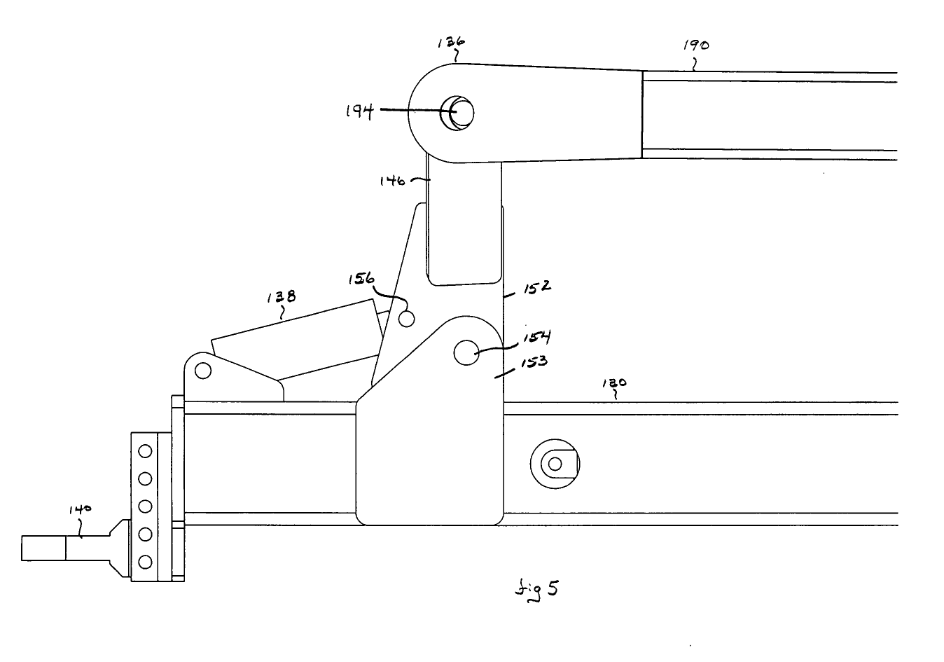

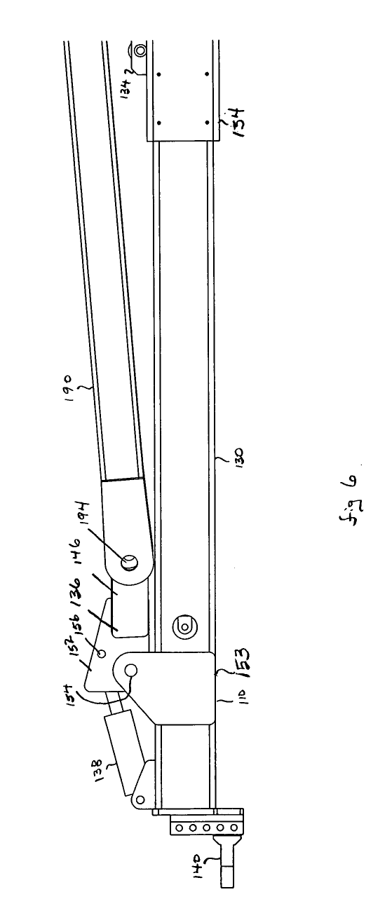

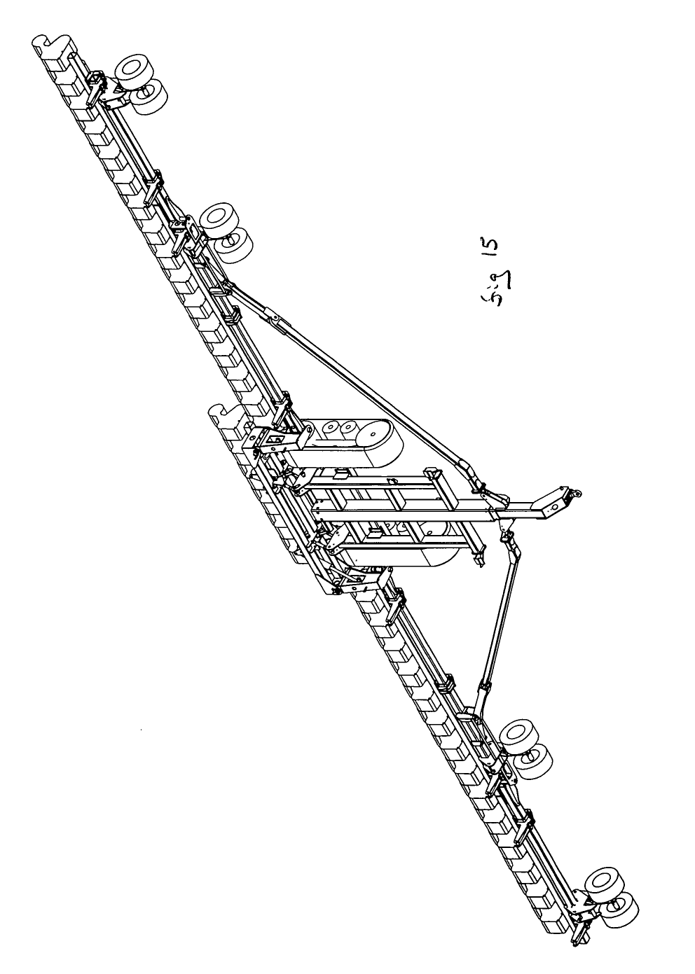

In order to be disposed in the transport configuration from a use (or operational) configuration (or position), the instant toolbars are raised to their uppermost position as depicted in FIGS. 1 and 18. Then, the yoke 136 is raised such that it is pivoted above the bracket 134 (from the position of FIG. 6 to the position of FIG. 5) and the wheel mechanism motors 252 are actuated. As the wheel mechanism motors 252 rotate the tires 250, the instant left and right wing frame assemblies and folding frame assembly are pivoted inwardly (from the position of FIGS. 1 and 18 through the position of FIG. 2). Simultaneously, the operator drives the prime mover forward to extend the tongue assembly inner member 130, thus further allowing the left and right wing frame assemblies 116 and 118 and the folding frame assembly 114 to pivot inwardly. The left and right wing frame assemblies 116 and 118 and folding frame assembly 114 continue to pivot until the folding frame members 190 and 192 are disposed in the notch 241 defined in the wheel mechanism bracket horizontal extension 240. The hydraulic rams 234 are then actuated to pivot the tires 250 upwardly until they contact lower surfaces of the folding frame members 190 and 192 and outboard surfaces of the tongue assembly outer member 132 (FIG. 16). At this point the instant implement is configured for transport with the tires 250 raised and the wing frame assemblies 116 and 118 fully supported in a raised position by the folding frame assembly.

When the present implement is to be configured from a transport configuration to a use configuration, the hydraulic rams 234 are actuated to pivot the tires 250 downwardly from contacting the lower surfaces of the folding frame members 190 and 192 and outboard surfaces of the tunnel assembly outer member 132. At this point, the tires 250 are in contact with the ground and the wheel mechanism motors 252 are actuated to rotate the tires 250 to pivot the left and right wing frame assemblies 116 and 118 and the folding frame assembly 114 outwardly. Immediately after actuating the wheel mechanism motors 252, the tractor is backed so as to retract the tongue assembly inner member 130 within the tunnel assembly outer member 132, thereby further assisting to pivot the left and right wing frame assemblies 116 and 118 and the folding frame assembly 114 outwardly. When the tongue assembly inner member 130 is fully retracted, the yoke 136 is pivoted until the yoke cross member 150 contacts the rearward edge of the bracket 134 to lock the yoke cross member 150 in the retracted position.

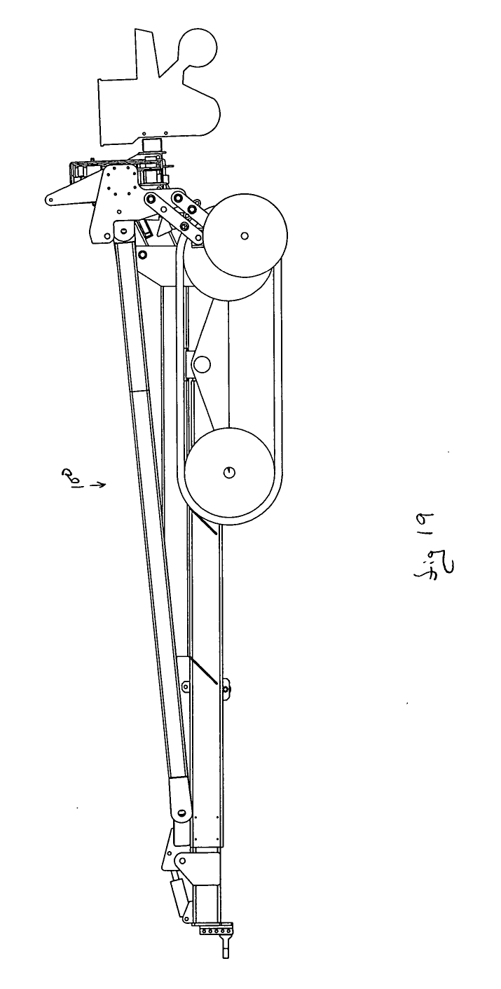

FIGS. 20 and 21 depict another embodiment of the instant telescoping tongue assembly indicated generally at 110′. The tongue assembly 110′ includes a pin 302 extending from an element 304 secured each side of the telescoping outer member 132. The 110′ also has a yoke 306. The yoke 306 includes respective left and right yoke elements 308 and 310 extending from a shaft 311. The shaft 311 is pivotally disposed through the telescoping inner member 130. Each left and right yoke element 308 and 310 includes respective outboard and inboard furcations 312 and 314. The furcations 312 terminate in the spherical bearing 151 as described above. The furcations 314 define a terminal slot 316 snugly accommodating the pin 302. The bearings 151 are connected to the left and right folding frames 190 and 192 as described above as well.

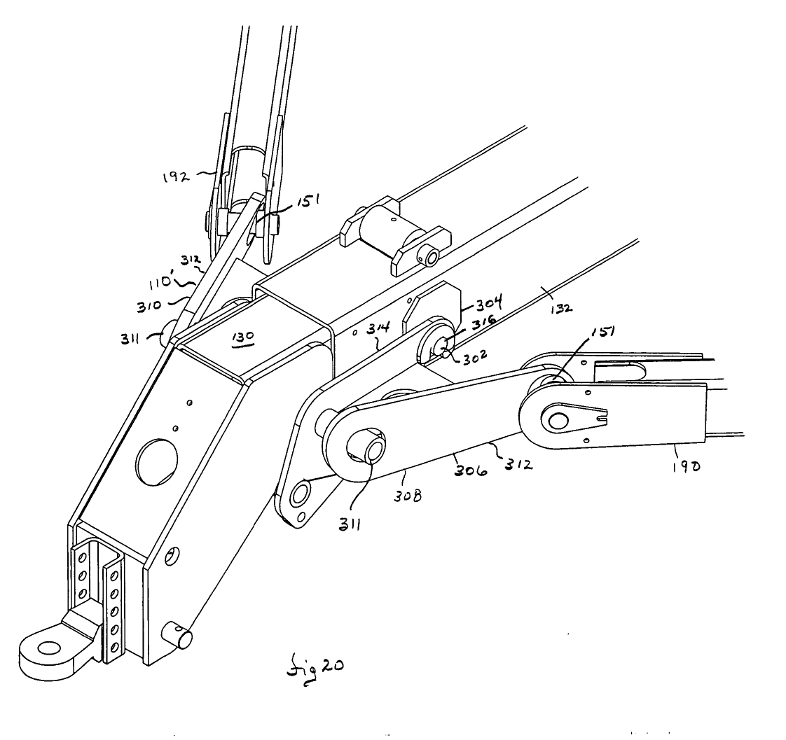

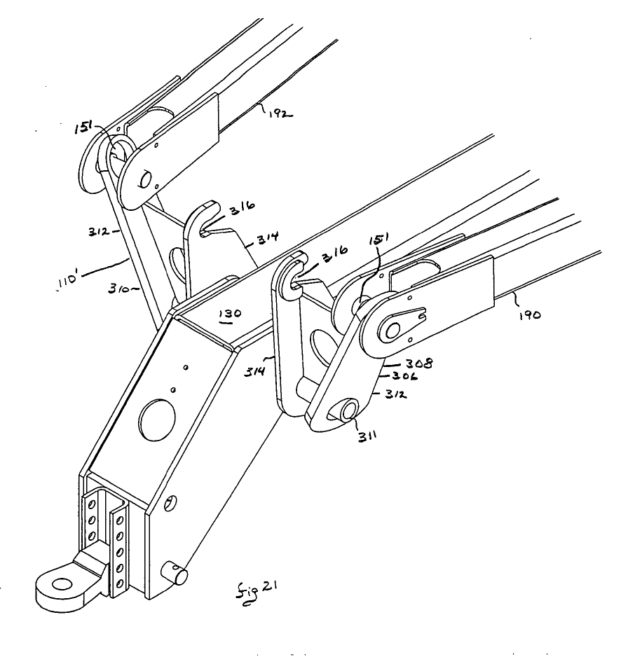

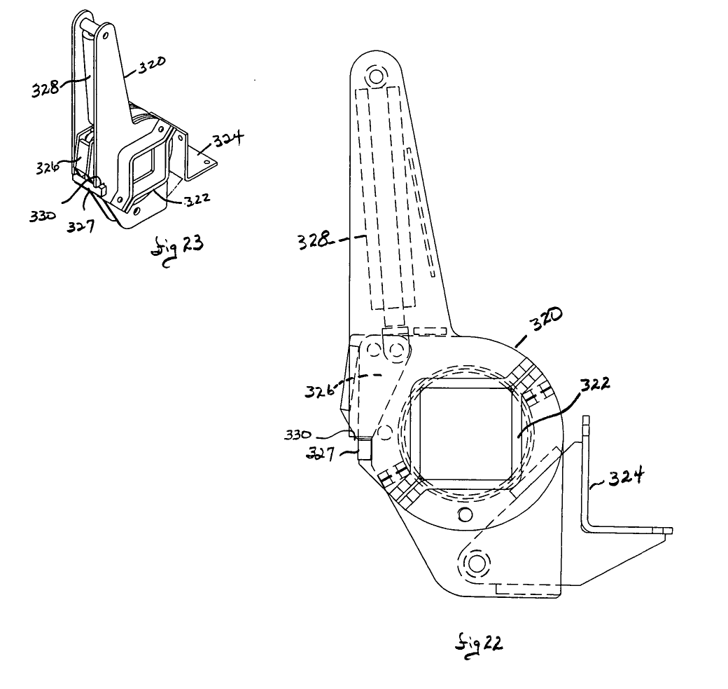

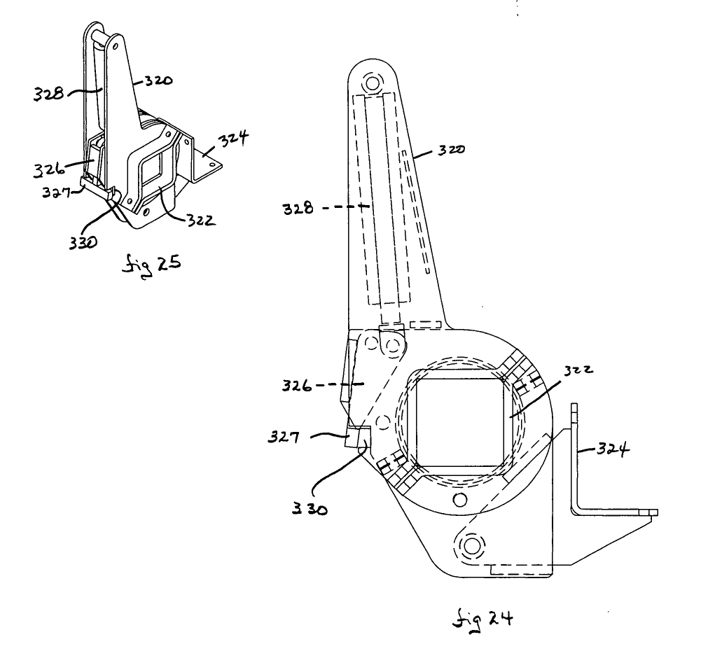

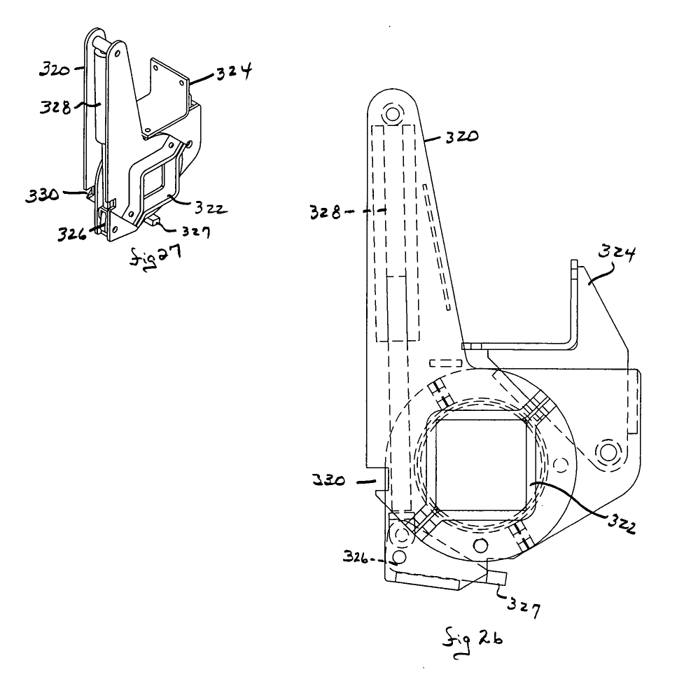

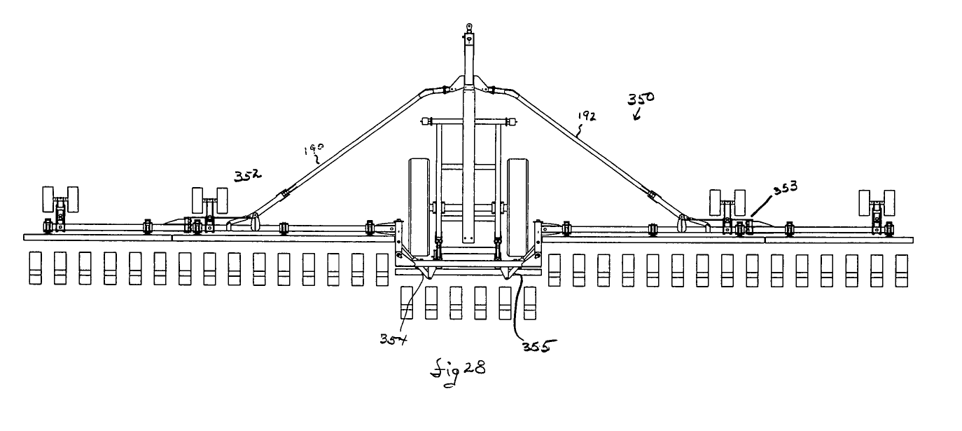

Referring to FIGS. 22-27, one embodiment of the instant toolbar bearing is depicted at 320 as an alternative to the bell cranks shown above. FIGS. 22 and 23 depict the toolbar bearing assembly 320 in a locked lowered position. FIGS. 24-25 show the toolbar bearing assembly 320 in an unlocked lowered position. FIGS. 26-27 show the toolbar bearing assembly 320 in a raised position. The toolbar 320 has a bracket assembly 322 which secures the bearing assembly 320 to one of the instant wing frame members. The bearing assembly 320 also includes a detachable, pivoting L-frame 324 and a locking mechanism 326. A cylinder (ram) 328 extends downwardly to initially pivot the locking mechanism 326, thereby pivoting the key element 327 out of the slot 330 from the position shown in FIGS. 22-23 to the position shown in FIGS. 24-25. As the cylinder (ram) 328 continues to extend, the locking mechanism and the linked L-frame 324 are then pivoted to the raised position shown in FIG. 26-27. One advantage of the present toolbar bearing is that in the locked position, that is when the key 327 is disposed in the slot 330, the locking mechanism cannot be displaced out of the lowered position as might otherwise occur due to forces exerted when operations such as planting or tillage are occurring. During these operations, a force is exerted on the toolbars held in place by the L-frames 324 that would tend to rotate the frames toward the raised position. However, the presence of the key 327 in the slot 330 provides resistance to the displacement which might otherwise occur. It is an advantage feature that the instant wing tool bars are pivoted around an axis coextensive with the wing frame members when being raised or lowered to thereby reduce the amount of force necessary to raise or lower the wing tool bars.

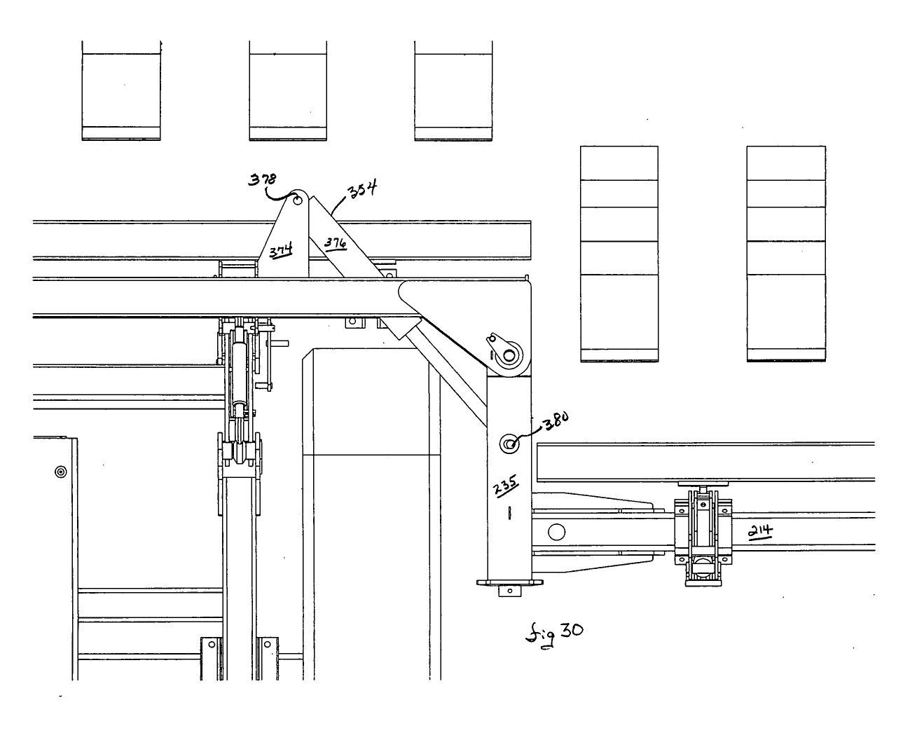

FIGS. 16 and 28-31 depict another embodiment of the instant implement generally at 350. The implement 350 differs from other embodiments by assist assemblies 352, 353, 354 and 355. These assist assemblies may be present in addition to, or to the exclusion of, the wheel mechanisms 230 and 232.

The assist assembly 352 or 353 is operably located where the left and right folding frame members 190 and 192 are pivotably attached to the left and right wing frame members 214 and 216. FIG. 31 shows the assist assembly 353. The assist assembly 352 is not depicted in detail because it is a mirror image of the assist assembly 353. The assist assembly 353 includes a bracket 358, a hydraulic cylinder (ram) 360, and a bracing structure 362. The bracket 358 attaches to the folding frame member 192 at a pivot 364. The hydraulic cylinder (ram) 360 attaches to an end of the folding frame member 192 at a pivot 366 and to a bracket 368 at a pivot 370.

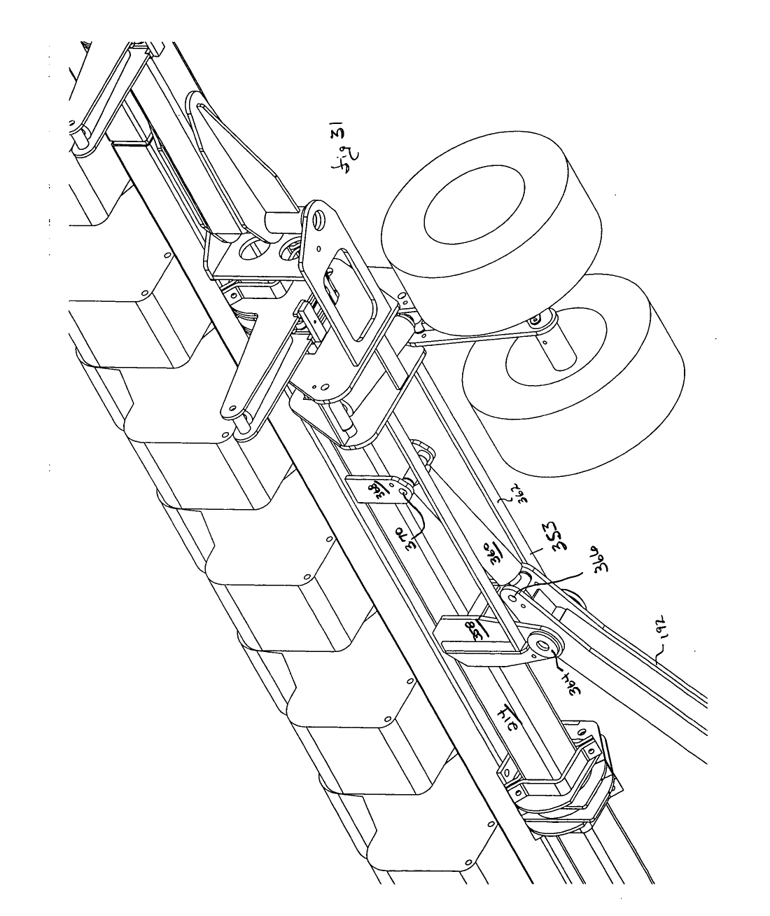

The assist assembly 354 is shown in detail in FIG. 30. The assist assembly 355 is not shown in detail because it is a mirror image of the assist assembly 354. The assist assembly 354 has a bracket 374 extending from the rear frame and attached to a hydraulic cylinder (ram) 376 at a pivot 378 and to the offset 235 at a pivot 380.

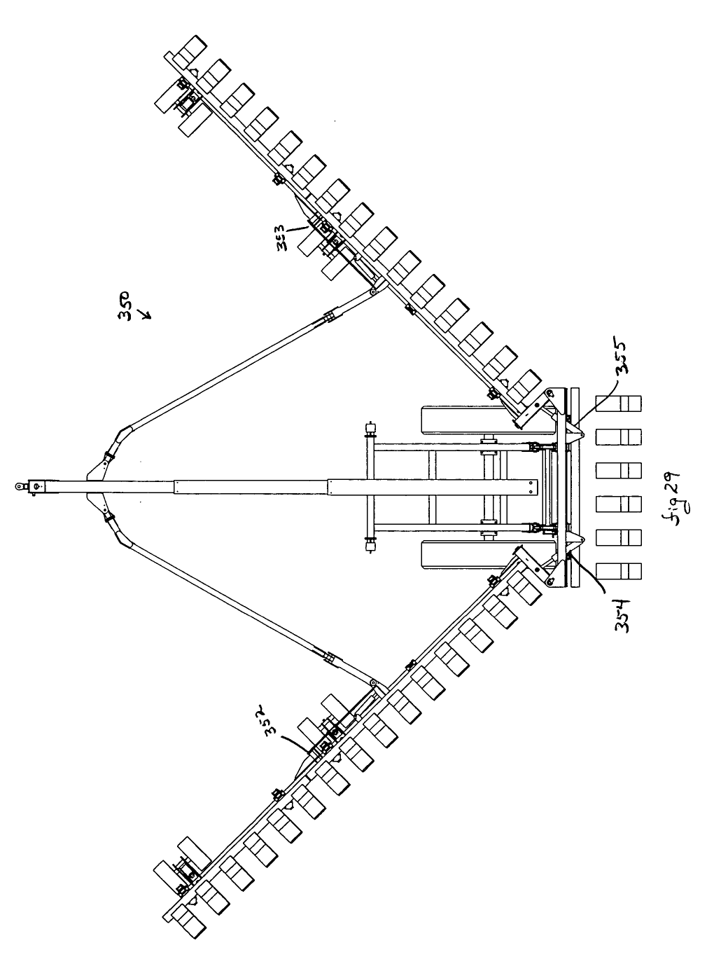

When the instant wing frame assemblies are folded in the transport position, the hydraulic cylinders 360 are activated to extend, thereby pivoting the folding frame members inwardly. Simultaneously, the cylinders 376 retract to fold the wing frame member 214 and 215 inwardly and extending the telescoping tongue assembly 110. While driving the tractor forward reduces the load on the cylinders 360 and 376, doing so is often unnecessary. Conversely, when the implement is being unfolded for use, the hydraulic cylinders 360 retract and the hydraulic cylinders 376 extend until the wing frame members are totally extended and the telescopic tongue assembly 110 is totally retracted as shown in FIG. 28.

Configuring the instant implement from the use configuration to the transport configuration may include the following steps:

1. Lifting the rear frame assembly 115 and left and right wing frame members 214 and 216 from the lowered position in which the implement is being used (e.g., to seed) to a raised position by actuating the rear frame assembly hydraulic cylinder 210 and the wheel assembly hydraulic cylinder 254, thereby extending the wheel mechanisms. Because the left and right wing frame members 214 and 216 are pivotally hinged to the rear frame assembly, raising the rear frame assembly will also raise inboard portions of the left and right wing frame members. Outboard portions of the left and right wing frame members are raised when the wheels are extended by the hydraulic cylinders 254.

2. Rotating the wing tool bars from a lowered position to a raised position by actuating the bell cranks 226 and 228 or tool bar bearings 320.

3. Pivoting the yoke 136 upwardly by actuating the hydraulic cylinder 138, thereby raising the left and right folding frame members 190 and 192 and thereby freeing the telescoping tongue assembly 110 to be extended.

4. Pivoting the left and right wing frame members 214 and 216 inwardly and extending the telescoping tongue assembly 110 by actuating the hydraulic motors 252 in the left and right wheel mechanisms 230 and 232 or by actuating the hydraulic cylinders 360 and 376. Optionally the prime mover can be driven forward to assist extending the telescopic tongue assembly. When the left and right wing frame members 214 and 216 are completely pivoted inwardly, the left and right folding frame members 190 and 192 will be disposed in the bracket notches 241 of each of the wheel mechanisms.

5. Retracting the wheel cylinders 254, thus raising the wheel mechanisms 230 and 232, to raise and bring the tires 250 into contact with the lower surface of each folding frame member 190 and 192, thereby securing the left and right wing frame assemblies to the folding frame members and transferring the weight of the left and right wing frame assemblies 116 and 118 to the respective left and right folding frame members 190 and 192.

Configuring the implement of this invention from the transport configuration to the use configuration includes the following steps:

1. Extending the wheel cylinders 254, thereby lowering the wheel mechanisms 230 and 232 to lower the tires 250, to bring the tires 250 out of contact with the folding frame members 190 and 192 and into contact with the ground, thereby transferring the weight of the left and right wing frame assemblies from the folding frame members 190 and 192 to the left and right wheel mechanisms. Additionally, the notches 241 of each of the wheel mechanisms 230 and 232 are lifted from the folding frame members 190 and 192.

2. Pivoting the left and right wing frame members 214 and 216 outwardly and retracting the telescoping tongue assembly 110 by actuating the hydraulic motors 252 in the left and right wheel mechanisms 120 and 132 or by actuating the hydraulic cylinders 360 and 376 until the left and right wing frame members 214 and 16 are fully extended and the tongue assembly is fully retracted. Optionally the prime mover can be backed to assist retracting the telescopic tongue assembly.

3. Pivoting yoke 136 downwardly by actuating the hydraulic cylinder 138, thereby lowering the left and right folding frame members 190 and 192. As the yoke 136 becomes fully lowered, the yolk locks the tongue assembly in the retracted position when the yoke abuts the bracket 134.

4. Rotating the wing tool bars from the raised position to a lowered position by actuating the bell cranks 226 and 228 or the tool bar bearings 320.

5. Lowering the rear frame assembly 115 and left and right wing frame members 214 and 216 from the raised position to the lowered position in which the implement will be used (e.g., seeding) by actuating the rear frame assembly hydraulic cylinder 210 and the wheel assembly hydraulic cylinder 254, thereby retracting the wheel mechanisms. Because the left and right wing frame members 214 and 216 are pivotally hinged to the rear frame assembly, lowering the rear frame assembly will also lower inboard portions of the left and right wing frame members. Outboard portions of the left and right wing frame members are lowered when the wheels are retracted by the hydraulic cylinders 254.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. An implement towable by a prime mover and having a transport position and an operational position, the implement comprising:
a telescoping tongue for attaching to the prime mover;
a main frame attached to the tongue;
a transport assembly comprising at least one of a plurality of ground engaging wheels and a plurality of ground engaging tracks, the transport assembly positioned under and supporting the main frame;
a folding frame pivotally attached to the main tongue, the folding frame comprising a pair of links;
a rear frame pivotally attached to the main frame and movable upwardly and downwardly; and
a left wing frame and a right wing frame, the left and right wing frames hinged to the rear frame assembly and pivoting from the folding frame,
the rear frame and left and right wing frames jointly pivotable between a raised transport position and a lowered operational position, the left and right wing frames pivoted with respect to the rear frame to be folded generally forwardly when in the transport position and to be generally parallel to the rear frame when in the operational position.

2. The implement of claim 1, the left wing frame and the right wing frame each comprising a wheel mechanism with a ground engaging wheel for engagement of the ground in the operational position but not the transport position.

3. The implement of claim 2, in which each said wheel mechanisms comprises a bracket and in which each of the respective wing frames is supported by the respective bracket engaged with the folding frame when the implement is in the transport position.

4. The implement of claim 3, in which the wheel mechanism comprises an upwardly and downwardly pivotable wheel and wherein when the wheel is pivoted upwardly the wheel contacts the folding frame when the implement is in the transport position.

5. The implement of claim 2, wherein the folding frame has a front end and the implement further comprising a lifting mechanism positioned on the tongue for elevating and lowering the front end of the folding frame.

6. The implement of claim 5, in which the lifting mechanism elevates the front end of the folding frame with respect to the tongue when the implement is in the transport position and lowers the front end of the folding frame with respect to the tongue when the implement is in the operational position, and wherein the interlocks with the tongue when the implement is in the operational position.

7. The implement of claim 5, in which the tongue comprises an inner member and an outer member and a bracket attached to the outer member and in which the lifting mechanism comprises a yoke pivotally attached to the inner member.

8. The implement of claim 7, in which the yoke pivots between a lowered locked position abutting the bracket and a raised unlocked position in a noncontacting relation to the bracket.

9. The implement of claim 7, in which the folding frame is raised as the yoke pivots from the lowered locked position to the raised unlocked position.

10. The implement of claim 2, in which the left and right wing frames can be pivoted horizontally and vertically at the rear frame.

11. The implement of claim 2, further comprising a first hydraulic cylinder pivotally connected to the folding frame and each of the left and right wing frames and a second hydraulic cylinder pivotally connected to the rear frame and each of the left and right wing frames, the first and second hydraulic cylinders at least partially folding the implement into the transport position and at least partially unfolding the implement into the operational position.

12. An implement, comprising:
a main frame;
a telescoping tongue extending from the main frame;
a yoke attached to the tongue and raisable and lowerable with respect thereto;
left and right diagonal links pivotally connected to the yoke; and
pivotally connected at the left wing, and right wing frames, the left and right wing frames pivotally connected to the respective left and right folding frames, the rear frame assembly vertically and pivotally attached to the main frame,
the implement configurable between a folded position and an unfolded position,
in which the folded position is characterized by the left and right folding frames being generally transverse with respect to the rear frame and the left and right folding frames being elevated by the yoke and by the left and right wing frames, and
in which the unfolded position is characterized by the left and right folding frame assemblies being perpendicular with respect to the rear frame and the rear, left wing, and right wing frames being lowered with respect to the folded position.

13. The implement of claim 12, further comprising a first hydraulic cylinder configuring each of the left and right folding frames between the folded position and the unfolded position.

14. The implement of claim 13, further comprising a second hydraulic cylinder configuring each of the left and right wing frames between the folded position and the unfolded position.

15. The implement of claim 12, in which the left and right folding frames support the respective left and right wing frames when the implement is in the folded position.

16. An implement having a transport position and an operational position, comprising;
a main frame;
a pair of ground engaging tracks supporting the main frame;
a movable tongue extending from the main frame in a principle direction of travel of the implement, the tongue having an extended position and a retracted position;
a rear frame pivotally attached to the main frame and movable upwardly and downwardly,
left and right wing frames pivotally connected to the rear frame to pivot from an extended position in a direction transverse to the principle direction of travel of the implement and a folded position extending along the tongue; and
a pair of links each having a front end and a rear end, the pair of links connecting between the movable tongue and left and right wing frames respectively, whereby when the implement is in the transport position the diagonal links are folded along the tongue with the tongue in its extended position and when the implement is in the operational position, the links are in a diagonal position with respect to the tongue and the left and right wing frames and the tongue is in the retracted position.

17. A method of manufacturing an implement, comprising:
attaching a telescoping tongue assembly to a main frame;
pivotally coupling a rear frame to a back side of the main frame;
hingedly attaching left and right wing frames to the rear frame;
pivoting connecting left and right folding frame members to the tongue assembly; and
pivotally coupling the left and right folding frame members to the respective left and right wing frames.

18. The method of claim 17, in which the tongue assembly comprises inner and outer members and in which the outer member is attached to the main frame.

19. The method of claim 17, further comprising the step of attaching the left and right folding members to the tongue through a yoke, the yoke raisable and lowerable with respect to the tongue.

20. The method of claim 17, comprising the step of pivotally connecting the left and right wing frames to the rear frame so that they are vertically and horizontally pivotable with respect td said rear frame.

21. The method of claim 17, in which the folding frame members can be vertically and horizontally rotated with respect to the tongue assembly.
